(19) United States
(12) Patent Application Publication
(10) Pub. No.: US 2022/0197776 A1
(43) Pub. Date: Jun. 23, 2022

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Kazuhiro Yoshimura, Kanagawa (JP)

(21) Appl. No.: 17/547,000

(22) Filed: Dec. 9, 2021

(30) Foreign Application Priority Data
Dec. 17, 2020 (JP) 2020-209351

(51) Int. Cl. G06F 11/36; G06F 8/75; G06F 8/73; G06F 8/36

(52) U.S. Cl. CPC G06F 11/3624; G06F 8/75; G06F 8/36; G06F 11/3688; G06F 8/73

(57) ABSTRACT

An information processing apparatus for coding a program includes an acquisition unit configured to acquire an input state of a user who performs the coding, a calculation unit configured to calculate search information for searching for information about the coding, based on the acquired input state, and an output unit configured to determine necessary information based on the search information and output the determined necessary information.

### BACKGROUND

### Field of the Disclosure

The present disclosure relates to an information processing apparatus, an information processing method, and a storage medium for coding a program.

### Description of the Related Art

In recent years, there has been an increase in the number of cloud computing systems that use, via a network, an information processing environment owned by a service provider, instead of owning an information processing apparatus that executes an application. Using the cloud computing system, various services, such as a shopping system for trading products via the Internet and a video distribution system, are provided. The cloud computing system, which can easily secure and release computing resources and reduce much of the burden of server--side management, will continue to be the standard for system development. In the system development using the cloud computing system, the system is linked with the services provided by each cloud vendor. For this purpose, it is common to use proprietary libraries and application programming interfaces (APIs) provided by each cloud vendor. Thus, in order to build a system that cooperates with each cloud service, program coding is to be performed according to the unique APIs, libraries, and conditions specified by each cloud vendor. In addition, because each cloud vendor performs more than 1,000 version upgrades per year, it is important, in the system development using the cloud computing system, to select and use the most appropriate services at the time of development. Thus, there is an issue where system developers need to investigate the mechanisms and usage of the latest services (libraries and APIs) and new ways of using the existing services, and this causes an increase in the investigation time, resulting in reduced development efficiency.

To address such an issue, Japanese Patent Application Laid-Open No. 2018-190261 discusses a method that detects the code corresponding to a specified code pattern from an implemented program, and replaces the code so that the processing corresponding to the code is performed on a cloud computing system. This method enables the system developers to perform processing on the cloud computing system without describing the program or setting information to be applied to the cloud computing system. Thus, the developers can focus on defining essential information processing procedures, thus improving the development efficiency.

The method discussed in Japanese Patent Application Laid-Open No. 2018-190261 reduces the number of investigations on the cloud computing system, but fails to reduce the number of man-hours spent on the single investigation.

### SUMMARY

The present disclosure is directed to reducing the number of man-hours spent on each investigation on coding a program.

According to an aspect of the present disclosure, an information processing apparatus for coding a program includes an acquisition unit configured to acquire an input state of a user who performs the coding, a calculation unit configured to calculate search information for searching for information about the coding, based on the acquired input state, and an output unit configured to determine necessary information based on the search information and output the determined necessary information.

Further features of the present disclosure will become apparent from the following description of exemplary embodiments with reference to the attached drawings.

### BRIEF DESCRIPTION OF THE DRAWINGS

FIG. 1 is a block diagram illustrating a hardware configuration of a development support apparatus according to one or more aspects of the present disclosure.

FIG. 2 is a schematic diagram illustrating a development support tool which is an output result of the development support apparatus according to one or more aspects of the present disclosure.

FIG. 3 is a block diagram illustrating a functional configuration of the development support apparatus according to one or more aspects of the present disclosure,

FIG. 4 is a flowchart illustrating a flow of processing according to one or more aspects of the present disclosure.

FIG. 5 is a block diagram illustrating a functional configuration of a search timing detection unit according to one or more aspects of the present disclosure.

FIG. 6 is a flowchart illustrating a flow of processing in step S402 of FIG. 4 according to one or more aspects of the present disclosure.

FIG. 7 is a schematic diagram illustrating a state of the development support tool at the moment when an input stop detection unit according to one or more aspects of the present disclosure detects stop of a user's input.

FIG. 8 is a schematic diagram illustrating a state of the development support tool at the moment when an error occurrence detection unit according to one or more aspects of the present disclosure detects occurrence of an error.

FIGS. 9A and 9B are schematic diagrams each illustrating a state of the development support tool at the moment when a range selection detection unit according to one or more aspects of the present disclosure detects a range selection.

FIG. 10 is a flowchart illustrating a flow of processing by a search aspiration level calculation unit according to one or more aspects of the present disclosure.

FIGS. 11A to 11C are schematic diagrams each illustrating an example of a necessary information database (DB) according to one or more aspects of the present disclosure.

FIG. 12 is a schematic diagram illustrating how a necessary information output unit according to one or more aspects of the present disclosure displays a necessary information list on the development support tool.

FIG. 13 is a block diagram illustrating a functional configuration of a development support apparatus according to one or more aspects of the present disclosure.

FIG. 14 is a flowchart illustrating a flow of processing according to one or more aspects of the present disclosure.

FIG. 15 is a schematic diagram illustrating an example of a necessary information DB according to one or more aspects of the present disclosure.

### DESCRIPTION OF THE EMBODIMENTS

Exemplary embodiments of the present disclosure will be described in detail below with reference to the accompanying drawings. The configurations illustrated in the exemplary embodiments described below are merely examples, and the present disclosure is not limited to the illustrated configurations.

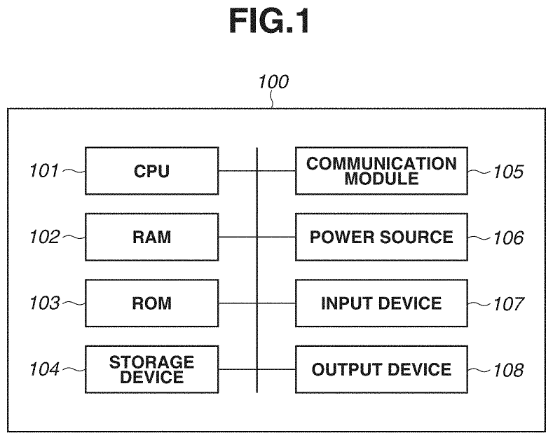

With reference to FIGS. 1 to 12, a series of processing from acquisition of an input state to display of information desired by a user according to a first exemplary embodiment of the present disclosure will be described below.

FIG. 1 is a block diagram illustrating a hardware configuration of a development support apparatus 100 according to the present exemplary embodiment.

Components of the development support apparatus 100 will be described with reference to FIG. 1.

The development support apparatus 100 is an information processing apparatus having a configuration similar to that of a general computer and includes a central processing unit (CPU) 101, a random access memory (RAM) 102, a read only memory (ROM) 103, a storage device 104, a communication module 105, a power source 106, an input device 107, and an output device 108. The CPU 101 is a processor that performs calculation processing, and may have a single CPU or multiple CPUs. The CPU 101 is assumed to he capable of processing tasks with threads. Using the RAM 102 as a work memory, the CPU 101 executes a program stored in the ROM 103. The storage device 104 is a storage medium for storing a program to be executed by the CPU 101 and data to be processed. A hard disk drive (HDD) or a solid state drive (SSD) can be used as the storage device 104. The communication module 105 is a communication interface that connects the development support apparatus 100 with an external computer such as a cloud service. Using the communication module 105, the development support apparatus 100 can input and output data to and from the RAM 102 and the storage device 104. It is desirable that the communication module 105 have two input/output ports, one for control and the other for data transport. The power source 106 is a power supply module of the development support apparatus 100 and may have multiple redundancies or be capable of storing power. The input device 107 is used to directly input a command to the development support apparatus 100 by using a keyboard, a mouse, or the like. The output device 108 displays information to the user by using a monitor or the like.

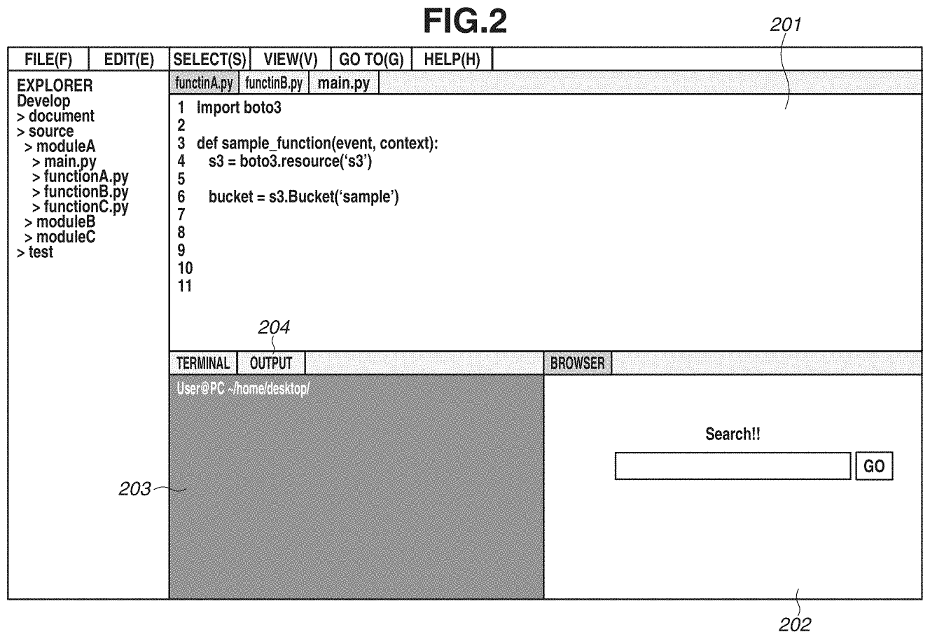

FIG. 2 schematically illustrates a development support tool which is an output result of the development support apparatus 100 and is displayed on the monitor or the like by the output device 108 according to the present exemplary embodiment. The screen output according to the present exemplary embodiment includes a code description section 201 for describing the source code of a program, and a web browser section 202 that is used to collect information. The screen also includes a terminal section 203 for entering a program execution command or the like, and an output section 204 for displaying an output, an error, or the like during the execution.

### <Processing by Development Support Apparatus>

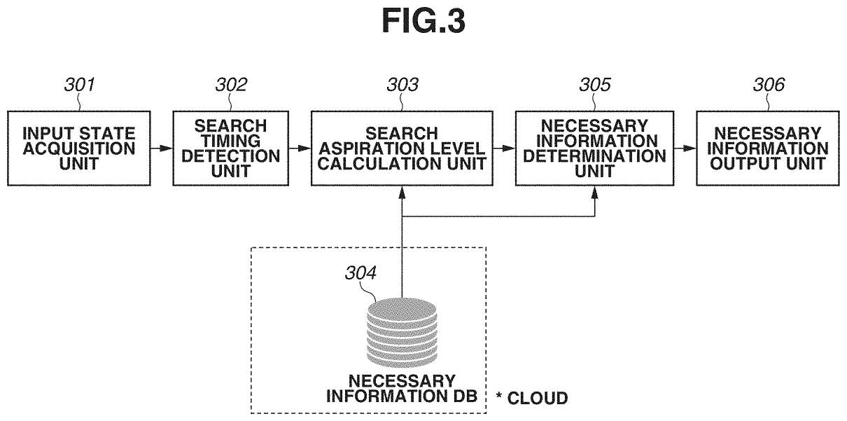

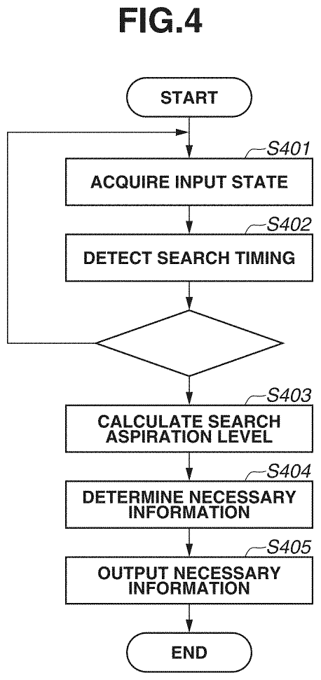

Processing performed by the development support apparatus 100 according to the present exemplary embodiment will be described with reference to a functional block diagram illustrated in FIG. 3 and a flowchart illustrated in FIG. 4. As illustrated in FIG. 3, the development support apparatus 100 according to the present exemplary embodiment includes an input state acquisition unit 301, a search timing detection unit 302, a search aspiration level calculation unit 303, a necessary information database (DB) 304, a necessary information determination unit 305, and a necessary information output unit 306. Functions of the above-described components of the development support apparatus 100 are implemented by the CPU 101 reading and executing a control program stored in the ROM 103. Alternatively, the development support apparatus 100 may be configured to include a dedicated processing circuit that corresponds to each of the components. A flow of processing performed by each of the components will be described next.

In step S401, the input state acquisition it 301 acquires an input state from the user. In the present exemplary embodiment, the input state acquisition unit 301 constantly acquires input signals from the keyboard and the mouse that are connected to the input device 107, and states of the web browser section 202, the terminal section 203, and the output section 204. The input state acquisition unit 301 outputs the acquired input state information about the entire screen to the search timing detection unit 302. Here, the input state information refers to continuous information such as the click position, movement path, and drag path of the mouse, a keyboard input, and status of each screen.

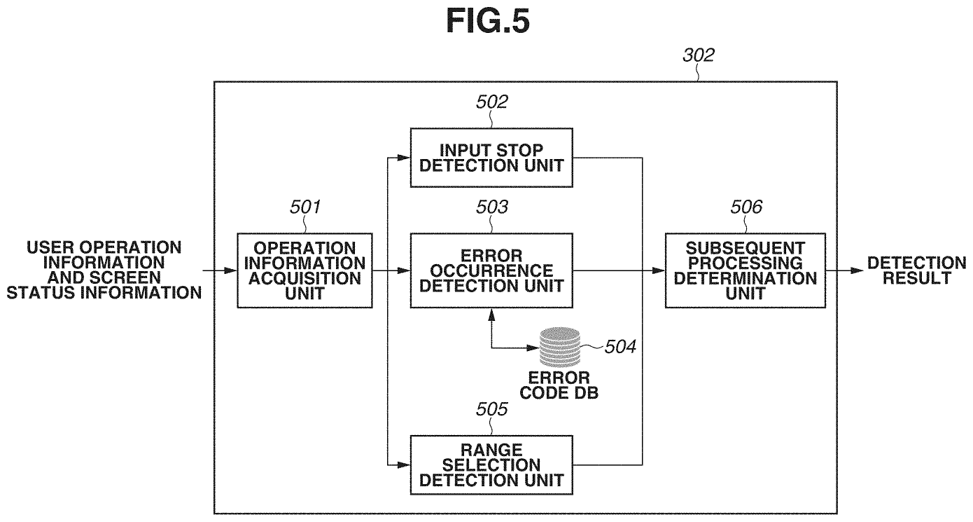

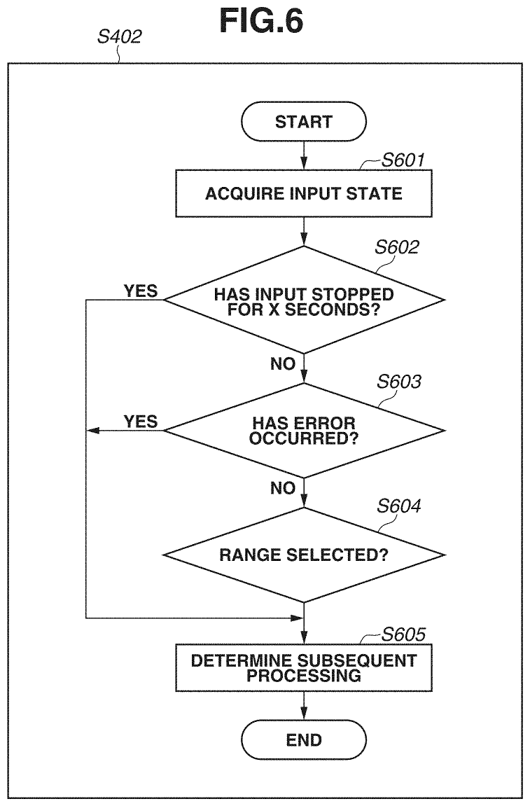

In step S402, the search timing detection unit 302 determines and detects, based on the input state information output from the input state acquisition unit 301, whether it is the timing when the user desires to search for information about coding or error handling, Details of processing by the search timing detection unit 302 will be described next with reference to a functional block diagram illustrated in FIG. 5 and a flowchart illustrated in FIG. 6.

As illustrated in FIG. 5, the search timing detection unit 302 according to the present exemplary embodiment includes an operation information acquisition unit 501, an input stop detection unit 502, an error occurrence detection unit 503, an error code DB 504, a range selection detection unit 505, and a subsequent processing determination unit 506. A flow of processing performed by each of the components will be described next,

In step S601, the operation information acquisition unit 501 acquires the input state information from the input state acquisition unit 301. The operation information acquisition unit 501 outputs user operation information, which is included in the acquired input state information, to the input stop detection unit 502 and the range selection detection unit 505, and outputs status information about each screen, which is included in the acquired input state information, to the error occurrence detection unit 503 and the range selection detection unit 505.

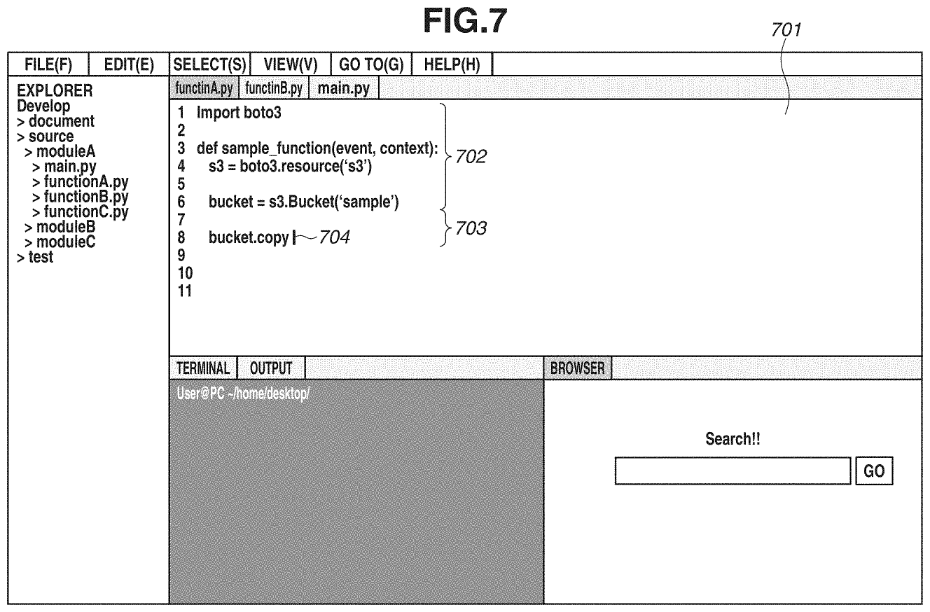

In step S602, based on the acquired user operation information, the input stop detection unit 502 detects stop of a user's input using the keyboard. More specifically, the input stop detection unit 502 detects whether the input of the code has stopped for a certain period of time while the user describes the code in the code description section 201 illustrated in FIG. 2. If the input of the code has stopped for a certain period of time, the input stop detection unit 502 determines that the user is having difficulty and thinking about how to describe the code correctly and is about to perform an information search, and detects the stop of the user's input as the search timing. FIG. 7 illustrates a state of the development support tool at the moment when the input stop detection unit 502 detects the stop of the user's input. In this state, the input stop detection unit 502 can acquire the input state in a code description section 701, and recognize a code part 702 that has already been input, a code part 703 that is being input, and the presence of an input cursor 704. More specifically, “b”, “u”, “c”, “k”, “e”, “t”, “.”, “c”, “o”, “p”, and “y” in the code part 703 that is being input are sequentially input from the operation information acquisition unit 501 to the input stop detection unit 502. If there has been no input after the input of “y” for a certain period of time (e.g., 3 seconds) or more, the input stop detection unit 502 determines that the user is having difficulty in how to describe the code and is about to perform an information search, and outputs information about the detection of the stop of the input to the subsequent processing determination unit 506. In a case where the input stop detection unit 502 does not detect the stop of the input, for example, in a case where the user has continued to input the code, the input stop detection unit 502 outputs, to the subsequent processing determination unit 506, information indicating that the stop of the input is not detected. In a case where the input stop detection unit 502 detects the stop of the user's input (YES in step S602), the processing proceeding to step S605 to end the processing by the search timing detection unit 302. In a case where the input stop detection unit 502 does not detect the stop of the user's input (NO in step S602), the processing proceeds to step S603 to continue the processing by the search timing detection unit 302. In the present exemplary embodiment, the stop of the input is detected by detecting a state where there has been no user input using the keyboard for a certain period of time, but the detection method is not limited thereto, and a method capable of detecting a state where the position of the input cursor 704 has not changed for a certain period of time may also be used.

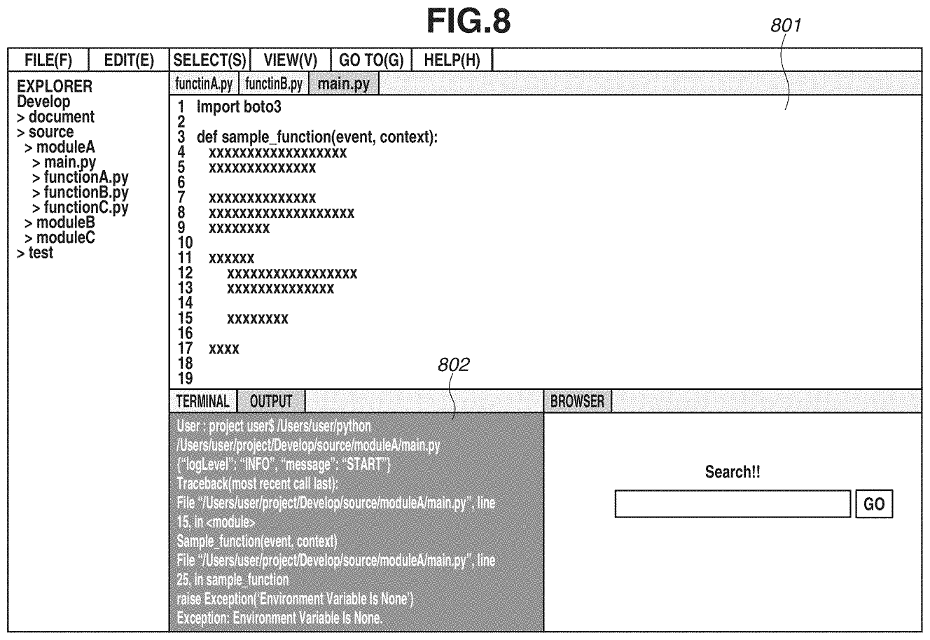

In step S603, based on the acquired status information about each screen, the error occurrence detection unit 503 detects whether an error has occurred in the program executed by the user. If the user executes the program based on the code described in the code description section 201 of FIG. 2 and an error has occurred, the error occurrence detection unit 503 determines that the user is about to perform an information search in order to investigate the cause of the error, and detects the occurrence of the error as the search timing. FIG. 8 illustrates a state of the development support tool at the moment when the error occurrence detection unit 503 detects the occurrence of the error. An output result of the user's execution of the program based on the code described in a code description section 801 is displayed in an output section 802. At this time, the error occurrence detection unit 503 extracts from the acquired status information about each screen, the content displayed on the output section 802 and determines, based on the displayed content, whether an error has occurred. In the present exemplary embodiment, the error code DB 504 is used to determine whether an error has occurred based on the displayed content.

If an error code included in the error code DB 504 is present in the displayed content, the error occurrence detection unit 503 determines that an error has occurred, and outputs information about the detection of the occurrence of the error to the subsequent processing determination unit 506. For example, assuming that “Exception” and “Environment Value Is None” are included in the error code DB 504, since this error code is present in the displayed content of the output section 802 illustrated in FIG. 8, the error occurrence detection unit 503 detects the occurrence of the error. The error code DB 504 also includes other error codes unique to the library to be used or selected from general words such as “Warning”, “Critical”, “Error”. If none of the error codes, which included in the error code DB 504, is present in the displayed content of the output section 802, the error occurrence detection unit 503 outputs, to the subsequent processing determination unit 506, information indicating that no error is detected. If the error occurrence detection unit 503 detects the occurrence of an error (YES in step S603), the processing proceeds to step S605 to end the processing by the search timing detection unit 302. If the error occurrence detection unit 503 does not detect the occurrence of an error (NO in step S603), the processing proceeds to step S604 to continue the processing by the search timing detection unit 302. In the present exemplary embodiment, the occurrence of an error is detected based on the displayed content of the output section 802. However, the method for detecting the occurrence of an error is not limited thereto, and a method capable of directly acquiring information about the execution success or failure of the program from the CPU 101 executing the program, and detecting the occurrence of an error based on the acquired information may also be used.

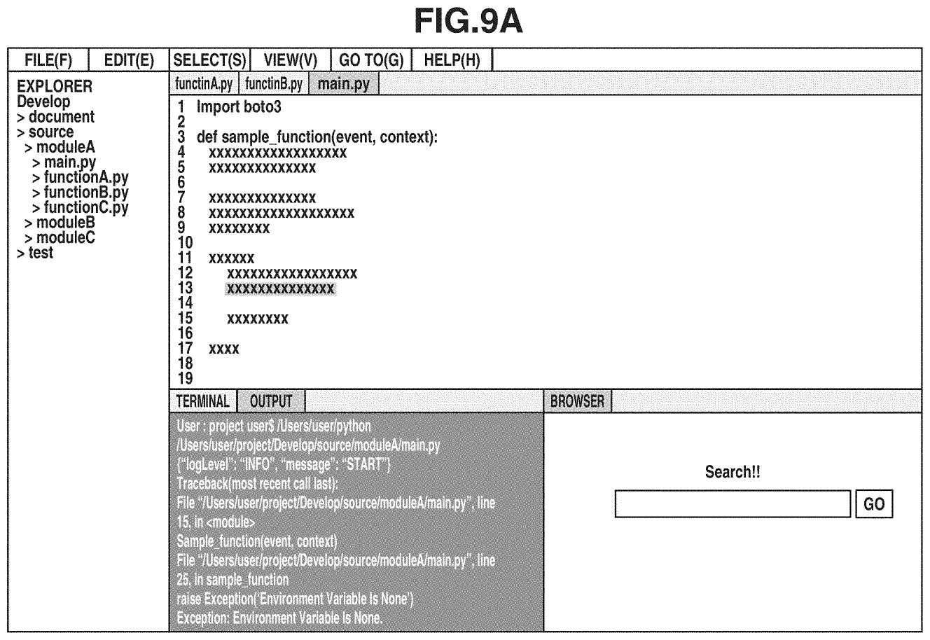

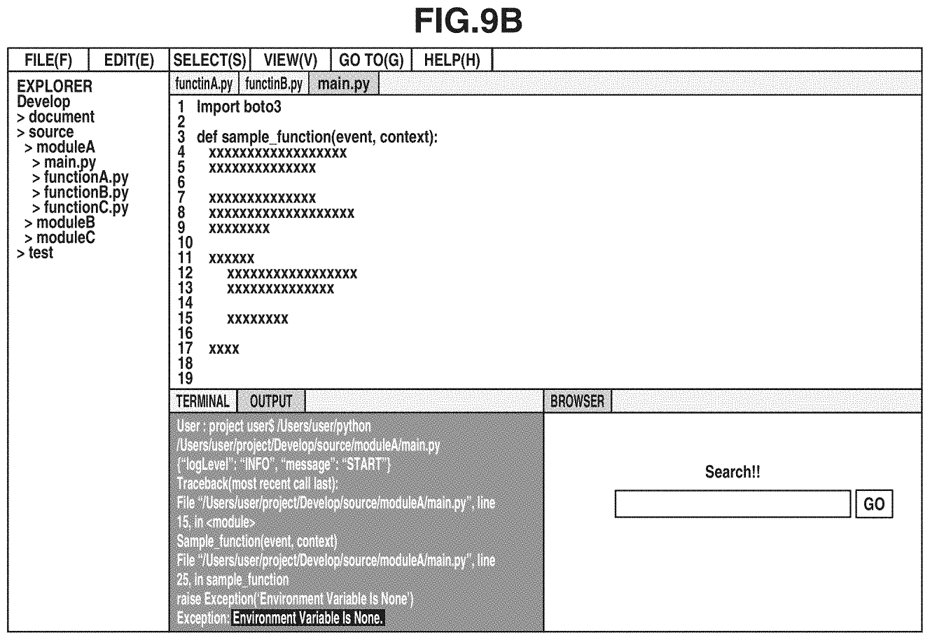

In step S604, the range selection detection unit 505 detects, based on the acquired user operation information and the acquired status information about each screen, whether the user makes a range selection of a part of the code or a part of the displayed content of the terminal section 203 or the output section 204. If the user makes a range selection of a part of the document such as the code by using an instruction unit such as the keyboard or the mouse, the range selection detection unit 505 determines that the user is about to search for information about a word included in the selected range, and detects the range selection as the search timing. FIGS. 9A and 9B each illustrate a state of the development support tool at the moment when the range selection detection unit 505 detects the range selection, FIG. 9A illustrates a case where the user makes a range selection of a part of the code. FIG. 9B illustrates a case where the user makes a range selection of a part of the error output. The range selection detection unit 505 first checks whether the acquired user operation information includes a range selection operation, such as “shift key+arrow key” in keyboard input or a dragging operation in mouse input. If the range selection operation is included, the range selection detection unit 505 then makes a collation with the acquired status information about each screen. If a part of the document is included in the selected range, the range selection detection unit 505 determines that the user has made the range selection to search for information and outputs, to the subsequent processing determination unit 506, information about the detection of the range selection. If the user does not perform any range selection operation, or if no document is included in the selected range, the range selection detection unit 505 outputs, to the subsequent processing determination unit 506, information indicating that no range selection is detected. Regardless of whether the range selection detection unit 505 detects a range selection or does not detect a range selection, the processing proceeds to step S605.

In step S605, the subsequent processing determination unit 506 determines the subsequent processing based on the detection results acquired from the input stop detection unit 502, the error occurrence detection unit 503, and the range selection detection unit 505. If any one of the respective detection results acquired from the input stop detection unit 502 the error occurrence detection unit 503, and the range selection detection unit 505 indicates the detection of the search timing, the subsequent processing determination unit 506 determines that the subsequent processing is search aspiration level calculation processing in step S403. If none of the detection results acquired from the input stop detection unit 502, the error occurrence detection unit 503, and the range selection detection unit 505 indicate the detection of the search timing, the subsequent processing determination unit 506 determines that the subsequent processing is input state acquisition processing in step S401. This is the end of the processing by the search timing detection unit 302 in step S402, and the processing proceeds to the processing step determined by the subsequent processing determination unit 506.

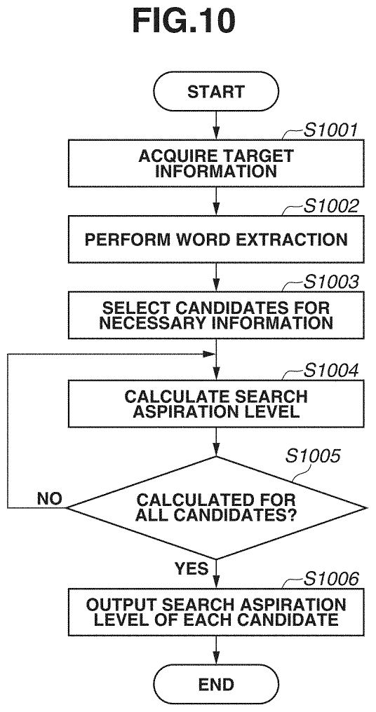

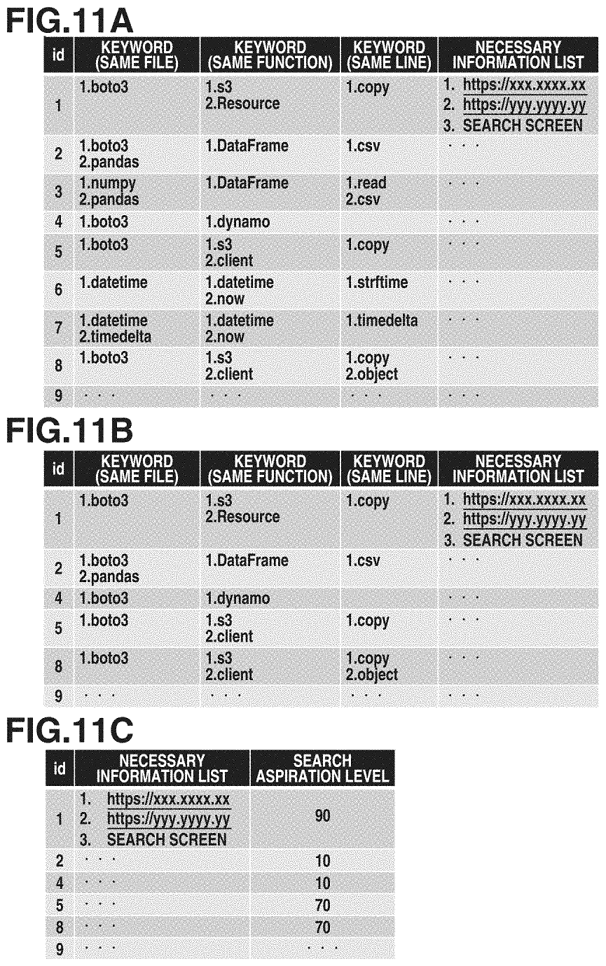

Returning to the description of the development support apparatus 100, in step S403, in response to the determination result by the search timing detection unit 302, the search aspiration level calculation unit 303 estimates what information the user desires to search for. At this time, the search aspiration level calculation unit 303 refers to the necessary information DB 304 that stores candidates for information desired by the user, and calculates, as search information, a search aspiration level for each of the necessary information candidates. In the present exemplary embodiment, it is assumed that all data necessary for the user is registered in advance in the necessary information DB 304. The search aspiration level indicates a measure of “how strongly the user needs the information”. A specific method for calculating the search aspiration level will be described using an example in which the stop of the user's input is detected in the state illustrated in FIG. 7. FIG. 10 is a flowchart illustrating a flow of processing by the search aspiration level calculation unit 303. In step S1001, the search aspiration level calculation unit 303 acquires target input information for calculating the search aspiration level. The target information depends on the unit detecting the search timing. If the stop of the input is detected, the entire file code where the input cursor 704 is present at the time of detection is the target information. If the occurrence of an error is detected, the error output in the output section 204 or the terminal section 203 is the target information. If a range selection is detected, the entire selected range corresponds to the target information. In step S1002, the search aspiration level calculation unit 303 extracts a related word included in the target information. The related word refers to a word to be entered into a search window when the user manually searches for information. In the present exemplary embodiment, if any of the words recorded in advance in the necessary information DB 304 is included in the target information, the word is extracted. FIG. 11A illustrates an example of the necessary information DB 304. All keywords included in a “Keyword (Same File)” Column, a “Keyword (Same Function) Column, and a “Keyword (Same Line)” Column in FIG. 11A are the related words according to the present exemplary embodiment. In the state illustrated in FIGS. 7 and 11A, a result of the word extraction includes “boto3” (in the same file), “s3” and “resource” (in the same function), and “copy” (in the same line). At this time, in a case where information about the position of the input cursor 704 is included in the target information, like a case where the stop of the input is detected, the word extraction is performed while making a distinction among the same file, the same function, and the same line. On the other hand, in a case where the information about the position of the input cursor 704 is not included in the target information, like a case where the occurrence of an error or a range selection is detected, the keywords included in the target information are extracted without a distinction among the same file, the same function, and the same line. In step S1003, the search aspiration level calculation unit 303 extracts the lines including the extracted words from the necessary information DB 304 to select the necessary information candidates. FIG. 11B illustrates the necessary information candidates selected by the search aspiration level calculation unit 303 in the state illustrated in FIGS. 7 and 11A. In step S1004, the search aspiration level calculation unit 303 calculates the search aspiration level for each of the necessary information candidates illustrated in FIG. 11B. A formula for calculating the search aspiration level is represented by the following formula (1):

Search aspiration level=α(x₁+x₂+x₃+ . . . )+β(y₁+y₂+y₃+ . . . )+γ(z₁+z₂+z₃+ . . . ) (1)

In the formula (1), x, y, and z are flags that indicate whether any of the keywords is included in the same file, the same function, or the same line, respectively, and are set to 1 if any of the keywords is included and are set to 0 if any of the keywords is not included. Subscript numbers each indicate the number in each item. For example, in a first line illustrated in FIG. 11B, if “boto3” is included in the same file, x1 is set to 1, and if “s3” is included in the same function, y1 is set to 1. If “Resource” is included in the same function, y2 is set to 1, and if “copy” is included in the same line, z1 is set to 1. Furthermore, α, β, γ are all weights and are constants satisfying a relation of α≤β≤γ that are specified in advance. However, in a case where the information about the input cursor 704 is not included in the target information, like a case where the occurrence of an error or a range selection is detected, and no distinction is made among the same file, the same function, and the same line, a relation of α=β=γ is satisfied. In the present exemplary embodiment, the search aspiration level is calculated using the formula (1), but the method for calculating the search aspiration level is not limited thereto, and a calculation method using weighting based on the distance from the position of the input cursor 704 or using machine learning may also be used. In step S1005, the search aspiration level calculation unit 303 checks whether the search aspiration level has been calculated for all the necessary information candidates selected in step S1003. If the search aspiration level has been calculated for all the candidates (YES in step S1005), the processing proceeds to step S1006. If the search aspiration level has not been calculated for all the candidates (NO in step S1005), the processing proceeds to step S1004. In step S1006, the search aspiration level calculation unit 303 outputs, to the necessary information determination unit 305, the search aspiration level calculated for each of the necessary information candidates. FIG. 11C illustrates a format for the output.

Returning to the description of the development support apparatus 100, in step S404, based on the calculated search aspiration level of each of the necessary information candidates acquired from the search aspiration level calculation unit 303, the necessary information determination unit 305 determines the information desired by the user at the timing detected by the search timing detection unit 302. In the present exemplary embodiment, the necessary information determination unit 305 determines, as the necessary information, the necessary information candidate having the highest aspiration level among the acquired search aspiration levels of the necessary information candidates. In the example of FIG. 11C, the necessary information “id 1” is determined as the necessary information. In the present exemplary embodiment, the necessary information is determined by selecting the one having the highest aspiration level among the candidates. However, the method for determining the necessary information is not limited thereto, and any other determination method may also be used, such as determining the top three candidates having the higher aspiration levels as the necessary information. The necessary information determination unit 305 outputs a necessary information list of the determined necessary information id to the necessary information output unit 306, and the processing proceeds to step S405.

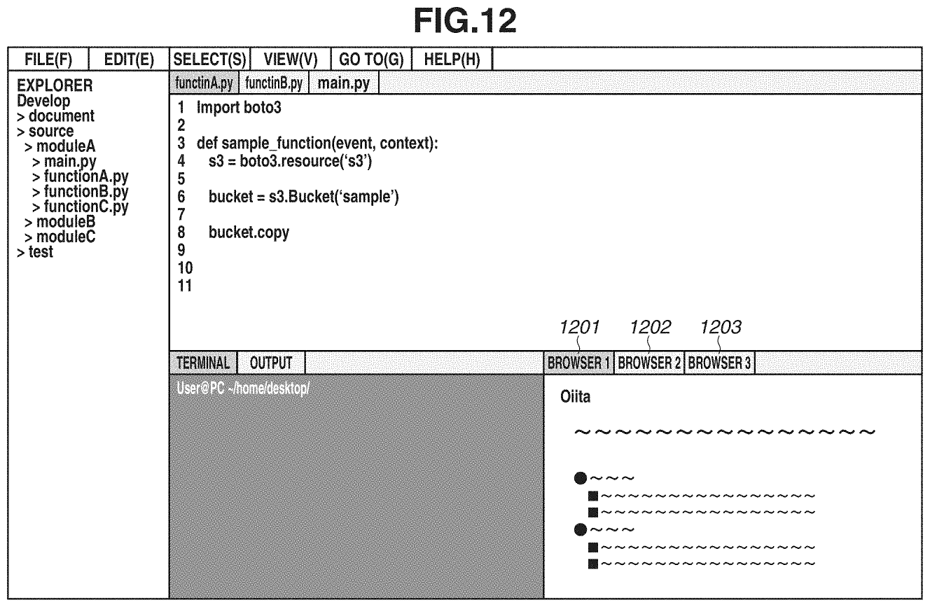

In step S405, based on the necessary information list acquired from the necessary information determination unit 305, the necessary information output unit 306 displays the necessary information list on the output device 108. FIG. 12 illustrates how the necessary information output unit 306 displays the necessary information list on the development support tool. A browser 1201 displays a first website registered in the necessary information list, a browser 1202 displays a second website registered in the necessary information list, and a browser 1203 displays a third website registered in the necessary information list. The display position is not limited to the position in the development support tool, but another web browser may be activated. In the present exemplary embodiment, the search timing detection unit 302 detects the timing when the user needs the information, and presents the necessary information at that timing, but the present exemplary embodiment is not limited thereto.

While the user activates the development support tool, the information that the user is likely to need may be presented all the time regardless of whether the search timing is detected or not.

The above is the flow of the processing performed by the development support apparatus 100 according to the present exemplary embodiment.

In the first exemplary embodiment, since the necessary information DB 304 is configured to register all data therein in advance, the necessary information cannot be updated based on update of a library provided by a cloud vendor, and thus the latest information desired by the user cannot be provided, for example. A second exemplary embodiment solves this issue.

In the second exemplary embodiment, the data of a necessary information DB is updated as appropriate, so that the information desired by the user including the latest information can be provided at the right timing. Processing performed by the development support apparatus 100 according to the present exemplary embodiment will be described focusing on differences from the first exemplary embodiment.

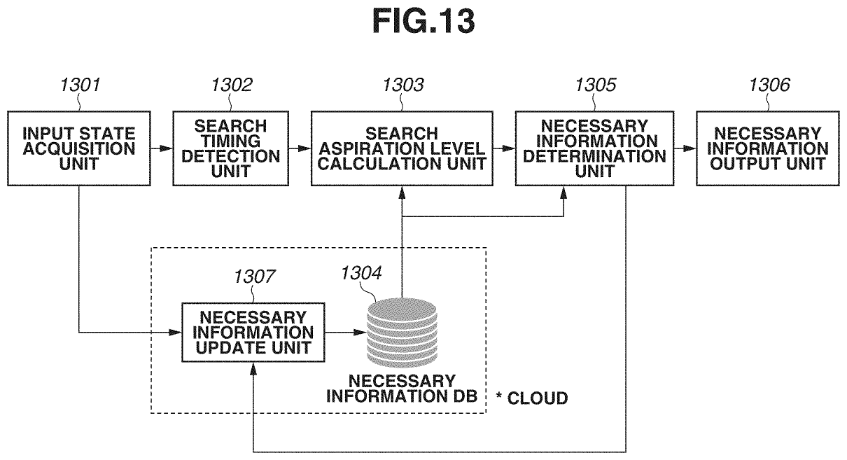

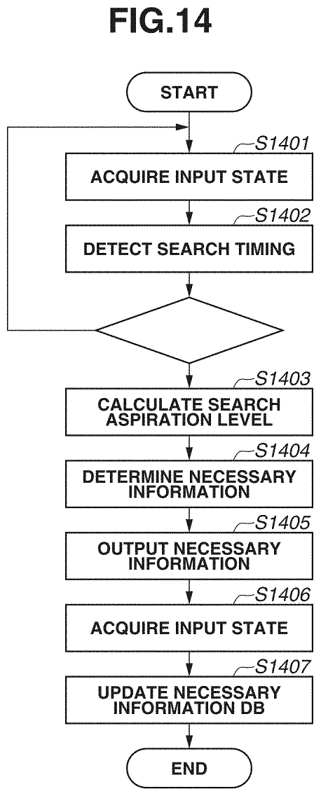

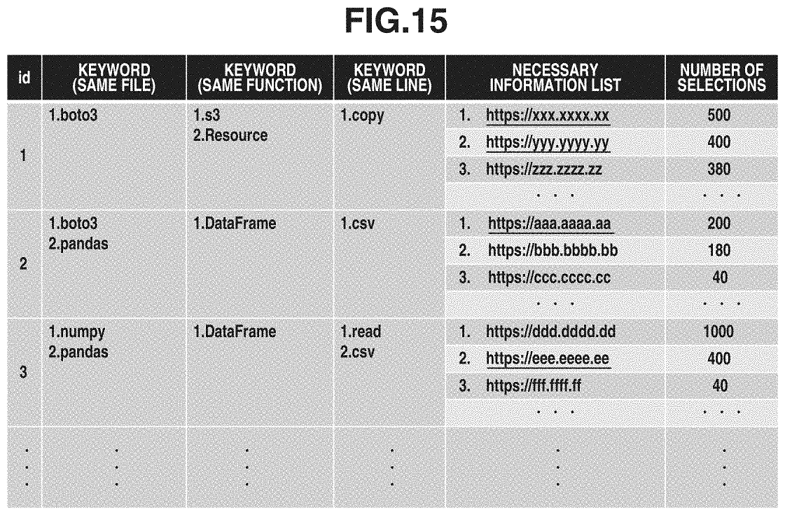

The processing performed by the development support apparatus 100 according to the present exemplary embodiment will be described with reference to a functional block diagram illustrated in FIG. 13 and a flowchart illustrated in FIG. 14. The difference from the first exemplary embodiment in the functional block diagram is that a necessary information update unit 1307 is added and the necessary information update unit 1307 updates the necessary information DB based on the information acquired from an input state acquisition unit 1301 and the information acquired from a necessary information determination unit 1305. The difference from the first exemplary embodiment in the flowchart is that steps S1406 and S1407 are added at the end to update the necessary information DB based on a users operation after the output of the necessary information according to the first exemplary embodiment. The necessary information DB according to the present exemplary embodiment is also different from that according to the first exemplary embodiment. FIG. 15 illustrates an example of the necessary information DB according to the present exemplary embodiment. The difference from the necessary information DB according to the first exemplary embodiment is that the number of pieces of necessary information registered in the necessary information list is no longer limited, and the number of times of selecting each of the pieces of necessary information (hereinafter also referred to as the number of selections) is associated with the corresponding necessary information. The number of selections refers to the number of times that the necessary information presented by the development support apparatus 100 to the user has been used by the user in the past. Since the number of pieces of necessary information registered in the necessary information list is no longer limited, new necessary information can be added at any time. A flow of processing performed by each of the components will be described next.

Similarly to the first exemplary embodiment, in processing from steps S1401 to S1405, the development support apparatus 100 detects the user's timing of an information search based on the input state information including the user operation information and the screen status information output by the development support apparatus 100, and outputs the necessary information. The present exemplary embodiment differs from the first exemplary embodiment in the subsequent processing.

In step S1406, the necessary information update unit 1307 acquires, from the necessary information determination unit 1305, the necessary information determined in step S1404, and acquires, from the input state acquisition unit 1301, the user operation information after step S1405.

In step S1407, the necessary information update unit 1307 updates the necessary information DB based on how the user behaves after referring to the necessary information displayed by the necessary information output unit 1306. More specifically, the user's behavior after referring to the necessary information can be roughly classified into three types. The first type is that the user has resumed the input of the code in the code description section 201 after referring to the displayed necessary information. The second type is that the user has performed an information search by himself/herself after referring to the displayed necessary information. The third type is that the user's behavior is neither of these two types. The necessary information update unit 1307 classifies the user's behavior (operation) after referring to the displayed necessary information, into one of these three types and performs necessary information DB update processing that is different for each of the types. In the case of the first type where the user has resumed the input of the code after referring to the necessary information, the necessary information update unit 1307 determines that the information desired by the user is included in the displayed necessary information, and increments the number of times of selecting the displayed necessary information by one. More specifically, the number of times of selecting the necessary information corresponding to the URL of the web page viewed immediately before the resumption of the input of the code is incremented by one. This makes it possible to easily present the information necessary for the user to any other user. In the case of the second type where the user has performed an information search by himself/herself after referring to the displayed necessary information, the necessary information update unit 1307 determines that the information desired by the user is included in the result of the information search performed by the user himself/herself. More specifically, the URL of the web page viewed immediately before the resumption of the input of the code is newly added to the necessary information list in the necessary information DB, or if the URL has already been included in the registered necessary information, the number of times of selecting the necessary information corresponding to the URL is incremented by one. This makes it possible to update the necessary information based on the update of the library provided by the cloud vendor, for example. In the case of the third type where the user's behavior is neither of the first and second types, the necessary information update unit 1307 does nothing in particular, and ends the processing. The necessary information update unit 1307 updates the necessary information DB by switching the processing based on the above three cases.

In the present exemplary embodiment, the information viewed immediately before the resumption of the input of the code is determined as the necessary information and the DB is updated. However, the method for updating the necessary information DB is not limited thereto, and a method capable of determining the information that has been referred to for the longest time as the necessary information may also be used. Furthermore, based on the necessary information DB updated according to the present exemplary embodiment, all users using the development support tool may be notified of trend information. More specifically, for example, the URL of the web page whose number of selections has rapidly increased may be displayed in the browsers of all the users.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above--described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)?), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2020-209351, filed Dec. 17, 2020, which is hereby incorporated by reference herein in its entirety.

What is claimed is:

1. An information processing apparatus for coding a program, the information processing apparatus comprising:
an acquisition unit configured to acquire an input state of a user who performs the coding;
a calculation unit configured to calculate search information for searching for information about the coding, based on the acquired input state; and
an output unit configured to determine necessary information based on the search information and output the determined necessary information.

2. The information processing apparatus according to claim 1, wherein the calculation unit updates the determined necessary information, based on the determined necessary information and the input state.

3. The information processing apparatus according to claim 1, wherein the input state includes stop of an input of the user.

4. The information processing apparatus according to claim 1, wherein in a case where a result of executing the program is an error, the calculation unit calculates the search information based on the input state at a time of occurrence of the error.

5. The information processing apparatus according to claim 1, further comprising:
a display unit configured to display the information about the coding; and
an instruction unit configured to enable the user to issue an instruction to select a part of the information,
wherein the calculation unit calculates the search information based on the selected part of the information.

6. The information processing apparatus according to claim 5, wherein the calculation unit calculates the search information based on a position of the part of the information selected using the instruction unit.

7. The information processing apparatus according to claim 6, wherein the search information is calculated based on whether a related word included in the part of the information is included in a same file, a same function, and a same line in a target of the search.

8. The information processing apparatus according to claim 1, wherein the output unit determines the necessary information in a database based on the search information and outputs the determined necessary information.

9. The information processing apparatus according to claim 8, further comprising an update unit configured to update the database based on a web page displayed before the user resumes the coding.

10. The information processing apparatus according to claim 9, wherein the update unit updates the database based on a period of time during which the web page has been displayed.

11. The information processing apparatus according to claim 9, further comprising a notification unit configured to notify the user of information about a trend in a case where the database is updated by the update unit.

12. An information processing method for coding a program, the information processing method comprising:
acquiring, with an acquisition unit, an input state of a user who performs the coding;
calculating, with a calculation unit, search information for searching for information about the coding, based on the acquired input state; and
determining, with an output unit, necessary information based on the search information and outputting the determined necessary information.

13. A non-transitory computer-readable storage medium storing a program for causing an information processing apparatus to execute an information processing method for coding a program, the method comprising:
acquiring an input state of a user who performs the coding;
calculating search information for searching for information about the coding, based on the acquired input state; and
determining necessary information based on the search information and outputting the determined necessary information.
